(19) United States
(12) Patent Application Publication
(10) Pub. No.: US 2006/0232392 A1
(43) Pub. Date: Oct. 19, 2006

(54) Brake lining wear indicator

(76) Inventors: Robert A. Emmett, Rennerod (DE); Wilfried Strauss, Wald-Michelbach (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 10/559,563

(22) PCT Filed: Mar. 11, 2004
(86) PCT No.: PCT/EP04/02527

§ 371 Date: May 30, 2006

(30) Foreign Application Priority Data
Jun. 3, 2003 (DE) 103250921

(51) Int. Cl. B60Q 1/00

(52) U.S. Cl. 340/454

(57) ABSTRACT

A brake lining wear indicator includes a connection for an external wear sensor, a power source for powering the wear sensor, an electronic processing device that is connected to a connection and a first and second display device connected to the electronic processing device, wherein the first display device has a continuous wear indicator for at least one brake lining and the second display device has at least one function display for the brake.

### BACKGROUND OF THE INVENTION

1. Technical Field

The invention relates generally to brake pad wear indication devices to announce the wear on the brake pads. This type of indicator device is become increasingly more important these days, because the on-going functional monitoring of the brakes plays an ever growing role within the context of the expanding security equipment of vehicles.

2. Related Art

This type of wear indication device is used, for example, as the ‘brake alert’ light in the vehicle, and indicates the reduced functionality caused by wear of the monitored brakes via a blinking light.

Other brake pad wear indication devices are also known, which are used in the servicing and repair of the vehicle in the auto repair facility. The preferred method here is to connect the wear indication device to an already existing CWI (Continuous Wear Indicator) connector on the vehicle.

These known brake pad monitoring systems only support identification and registration of the total wear of the internal and external pads of a brake, with no possibility to conduct a differential analysis or a localization of the pad wear.

### SUMMARY OF THE INVENTION

The present invention makes possible a differentiated and detailed pad wear indication.

A brake pad wear indicator device of the invention includes connectivity to an external wear sensor, a power source to provide energy to operate the wear sensor, an electronic processing unit linked with the connection and linked with an electronic processing unit hooked to a primary and secondary display device, where the primary display device continuously displays the wear of at least one pad on one brake, and the secondary display device depicts at minimum the functionality display for the brake.

This invention provides a primary display device for continuous evaluation of the pad wear, as well as a secondary display device showing the functioning of the brakes. With the continuous display, the user is able to optically monitor the brake pad wear over time. In contrast, the functionality display delivered via the secondary display device displays the existing orderly functioning or possible degraded functioning, and is therefore capable of directly notifying the user immediately of any reduced functioning.

It is preferred that the primary display device continuously display wear indications for the inner brake pad and for the outer brake pad, so that a differential analysis of the pad wear is made possible.

Alternatively it is preferred that the primary display device deliver a continuous wear display for a drum brake.

It is further preferred that the primary display device provide a continuous summary total wear indication for the total wear of the inner and outer brake pads. In this way the previously available summary total wear indication can be evaluated visually.

Further, it is preferred that the secondary display device include a functionality display for the parking brake. With this functionality display for the parking brake the orderly functioning or the failure of the parking brake can be displayed in the operating state. This display is supported via a gauge contact between the brake and the brake disc.

Further, it is preferred that a functionality display for brake adjustment be defined, to address indication of a need to adjust the brakes. This display would also provide an immediate ‘Service Needed’ display, in conjunction with the continuous monitoring.

It is further envisioned that a functionality display be provided for a brake failure. This functionality display should immediately indicate the failure or degradation of the brakes, so that the user can initiate appropriate actions immediately.

It is further preferred that all components of the wear display devices be contained within one housing, The functionality displays ‘Adjustment’ and ‘Error’ would provide for an effective evaluation of the continuous display. The evaluation occurs in the directly connected electronic processing device, or via software.

It is further preferred that the device have a first function button to call up the various displays from the primary display device. In that way the various continuous displays can be confirmed and invoked. The first function button is connected to the electronic processing device.

A second function button is preferred, to invoke the displays of the second display device. The second function button enables the call-up and confirmation of the various functionality displays of the secondary display device.

Finally, a differentiation wear device is preferred and envisioned, to display the different amounts of wear between the inner brake pad and the outer brake pad.

A CWI (Continuous Wear Indicator) control sensor that is well known is shown in EP 1270983 A1. The measurement of the brake pad wear is accomplished by means of a metal foil wrapping, the resistance of which measurably changes with wear.

The invention is suitable for standalone use in a workshop facility. It is also envisioned to be implemented as a supplemental component of a ‘brake alert’ device, which is itself installed into a motor vehicle.

### THE DRAWINGS

Further advantages, characteristics, and application opportunities of the invention in the following description and drawing, in which:

FIG. 1 is a functionality diagram of an implementation of an invention-related brake pad wear indicator device.

### DETAILED DESCRIPTION

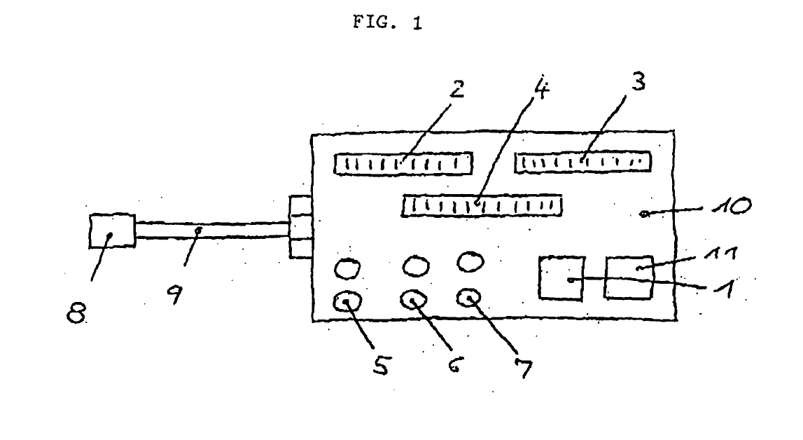

The brake pad wear indication device represented in FIG. 1 has a connection 8 for an external wear sensor, which is installed into the automobile (not shown), and which can be connected to the connection 8 by an interconnecting cable 9. The connection is shown as a plug unit (CWI), with a cable 9 leading into a housing 10 of the device. The housing 10 includes a power source (not shown), as a rule this would require a 5 volt battery, connected to connection 8, and thereby transmitting the power to the wear sensor for measurement. Further the device includes an electronic processing unit suitable to extract the required individual display signals from the measurement signals provided by the wear sensor.

A first display device is foreseen which provides a continual wear display 2 for the inner pad of the connected brake. Further the first display device shows a continuous wear indication 3 for the outer pad of the brake. Finally, the first display device includes a summary total wear display 4 for the summary total of the wear of the inner pad and the outer pad. The three displays of the first display device are represented as scalar displays with pointer, or as a switchable LED display, which provides a direct visual evaluation of wear.

Further, functionality displays for secondary display devices are in this device.

A functionality display 5 for a parking brake is included, indicating two conditions. The first condition indicates the orderly functioning of the parking brake; the other condition indicates a degradation or failure of the parking brake. The capture of the function of the parking brake occurs via a gauge contact between the brake and the brake disc. One additional display 6 is foreseen for the adjustment function of the brake. This display 6 has two display conditions, indicating the immediate requirement to adjust the brake, or indicating the orderly functioning without requiring adjustment. Finally a functionality display 7 is foreseen to address a brake failure, which also consists of two display conditions.

Further a first function button 1 is shown, which is connected to the processing unit, enabling activation of displays 2, 3, and 4. By activation of function button 1 can display 2 the wear on the inner brake pad, can display 3 the wear on the outer brake pad, and can display 4 the summary wear total for evaluation.

The inventive device is therefore suited to display the wear per pad, the summary total wear, the differential wear, the functioning of the parking brake, and the functioning of adjustment monitoring as well as displaying a brake failure.

In this way the invention is suited for installation into a motor vehicle or into a service area as a standalone device for brake function evaluation.

1-10. (canceled)

11. A brake pad wear indicator device having a connection for coupling the device to an external wear sensor associated with brake pads of vehicle brakes, a power source for supplying power to the device and primary and secondary display devices operative to indicate wear of the pads, wherein said primary display device is operative to provide continuous display for indicating a wear condition for one inner brake pad and one outer brake pad and providing a continuous differentiation wear display showing the difference in wear between the inner and outer pad; and where the secondary display device is operative to display at least one functionality display for the vehicle brakes.

12. The brake pad wear indicator device of claim 11 wherein the primary display device has a continual wear display for a drum brake.

13. The brake pad wear indicator device of claim 11 wherein the primary display device has a continual summary total wear display for the total of all wear on the inner pad and the outer pad.

14. The brake pad wear indicator device of claim 11 wherein the functionality display of the secondary display device is associated with a parking brake.

15. The brake pad wear indicator device of claim 11, wherein the functionality display of the secondary display device is associated with a brake adjustment status.

16. The brake pad wear indicator device of claim 11, wherein the functionality display of the secondary display device is associated with a brake failure state.

17. The brake pad wear indicator device of claim 11 including a housing.

18. The brake pad wear indicator device of claim 11, including a first function button connection to the electronic processing unit operative to activate or to invoke the display of the first display device.

19. The brake pad wear indicator device of claim 18, including a second function button connected to the electronic processing unit operative to activate to invoke the display of the second display device.

20. The brake pad wear indicator device of claim 11 wherein the displays of the first display device and/or the displays of the second display device may be activated concurrently to display at the same time.
